(19) United States
(12) Patent Application Publication
(10) Pub. No.: US 2019/0230910 A1
(43) Pub. Date: Aug. 1, 2019

(54) FISHING FLOAT

(71) Applicant: Akiyuki SHIKINA, Nanjo-shi, Okinawa (JP)

(72) Inventors: Akiyuki SHIKINA, Nanjo-shi, Okinawa (JP); Makoto ENDO, Imizu-shi, Toyama (JP); Emi KANAYAMA, Imizu-shi, Toyama (JP)

(21) Appl. No.: 16/340,572

(22) PCT Filed: Aug. 29, 2017
(86) PCT No.: PCT/JP2017/030837

§ 371 Date: Apr. 9, 2019

(30) Foreign Application Priority Data
Oct. 21, 2016 (JP) 2016-206665

(51) Int. Cl. A01K 93/00

(52) U.S. Cl. CPC A01K 93/00

(57) ABSTRACT

In a fishing float including a buoyant body and a line-passing ring, the buoyant body constitutes a rotating body that rotates about a central axis as rotation center passing through the buoyant body in an up-down direction, and includes a recess located on a lower side of the buoyant body and formed so as to recede upward. The recess is deepest at the rotation center of the rotating body, and becomes shallower in a direction away from the rotation center of the rotating body. The line-passing ring is supported by the buoyant body, and attached to the buoyant body at a position corresponding to the rotation center of the rotating body, so as to protrude upward from an upper surface of the buoyant body.

### TECHNICAL FIELD

The present disclosure relates to a fishing float.

### BACKGROUND ART

Float fishing rigs can be broadly classified into two types, namely a fixed rig and a slip float rig. The fixed rig refers to a rig in which a fishing float is fixed to a fishing line. The slip float rig refers to a rig in which the fishing float is movably attached to the fishing line. In the case of the slip float rig, it is a common practice to attach a stop knot and a bead to the fishing line, so as to limit the range in which the fishing float can move along the fishing line (in other words, the maximum depth of the fishing hook hanging from the fishing float). Such a slip float rig is called a partial slip float rig. The slip float rig without the stop knot and the bead, in other words the slip float rig in which the moving range of the fishing float is not limited, is called a full slip float rig. The full slip float rig enables a reaction of target fish to be sounded, while allowing the fishing hook to descend, and is therefore useful in a case where the depth of the “range” (region where the target fish are present) is unknown.

Various types of floats, such as a sliding float, a horizontal float, and a float with tube, are utilized for the full slip float rig, among which the sliding float is typically employed (see Patent Literature 1 and 2). The sliding float is a fishing float that includes an inner tube penetrating through the main body (buoyant body) of the float in an up-down direction, so that the fishing line can be passed through the inner tube. In the full slip float rig, the fishing line can freely pass through the inner tube, until the fish bites the bait attached to the fishing hook. Under such a condition, the fishing line is literally “freely movable.” However, once the fish bites the bait and attempts to take the bait away, the posture of the sliding float is changed. To be more detailed, when the fish that has bitten the bait pulls the fishing line, the sliding float, thus far in an upright posture, falls down. When the sliding float falls down, the fishing line contacts the inner surface of the inner tube thereby generating friction, so that the sliding float is pulled by the fishing line. As result, the sliding float sinks under water by being pulled by the fish.

In view of the float sinking under water, the angler performs what is known as “striking.” In other words, the angler lifts up the fishing hook by pulling the fishing line, thus to hook the mouth of the fish, with the fishing hook.

### CITATION LIST

### Patent Literature

Patent Literature 1: Japanese Utility Model Registration No. 3070561

Patent Literature 2: Unexamined Japanese Patent Application Kokai Publication No. 2000-78942

### SUMMARY OF INVENTION

### Technical Problem

By the conventional slip float fishing that utilizes the sliding float, as mentioned above, the angler visually recognizes the movement of the fishing float, after which the angler “strikes.” However, the movement of the fishing float takes place with a slight delay, after the fish bites the bait. Accordingly, when an unskilled angler “strikes” upon visually recognizing the movement of the fishing float, the “striking” is often delayed, and resultantly the angler misses the fish.

Therefore, some anglers do not like to “strike” in view of the movement of the fishing float. In other words, some anglers prefer directly sensing the “pull” caused by the fish that has bitten the bait, and “striking” at the time point that the “pull” has been sensed. However, the sliding float used in the conventional slip float rig serves as a kind of buffer, which makes it difficult for the angler to sense the “pull.”

The present disclosure has been accomplished in view of the foregoing situation, and provides a fishing float suitable for the slip float fishing, and configured to facilitate the “pull” caused by the “bite” of the fish to be transmitted to the angler.

### Solution to Problem

In an aspect, the present disclosure provides a fishing float including a buoyant body and a line-passing ring. The buoyant body constitutes a rotating body that rotates about a central axis as a rotation center passing through the buoyant body in an up-down direction, and includes a recess located on a lower side of the buoyant body and formed so as to recede upward. The recess is deepest at the rotation center of the rotating body, and becomes shallower in a direction away from the rotation center of the rotating body. The line-passing ring is supported by the buoyant body, and attached to the buoyant body at a position corresponding to the rotation center of the rotating body, so as to protrude upward from an upper surface of the buoyant body.

The fishing float may include a weight located under, and supported by, the buoyant body.

The fishing float may include a shaft member penetrating through the buoyant body in the up-down direction. The line-passing ring may be fixed to an upper end portion of the shaft member, and the weight may be fixed to a lower end portion of the shaft member.

The buoyant body may include a through hole for the shaft member to be inserted, and a gap may be defined between the through hole and the shaft member.

The weight may include a weight piece chamber for removably accommodating a weight piece.

### Advantageous Effects of Invention

The fishing float configured as above includes the line-passing ring attached to the buoyant body so as to protrude from the upper surface thereof, so as to allow the fishing line to be passed through the line-passing ring. Accordingly, with the full slip float rig incorporated with the fishing float of the present disclosure, the force of the fish pulling the fishing line can be directly transmitted to the fishing rod. Therefore, the angler can directly sense the “pull” of the fish, to thereby “strike” without delay. Consequently, the angler can effectively avoid missing the fish, compared with the case where, as with the conventional fishing rig, the angler becomes aware of the “pull” of the fish in view of the movement (floating and sinking) of the fishing float, and “strikes” thereafter.

### BRIEF DESCRIPTION OF DRAWINGS

FIGS. 1A to 1C are drawings each showing a configuration of a fishing float according to Embodiment 1 of the present disclosure, FIG. 1A being a plan view of the fishing float, FIG. 1B being a side view of the fishing float, and FIG. 1C being a cross-sectional view of the fishing float, taken along a plane indicated by a line A-A′ in FIG. 1A;

FIGS. 2A and 2B are schematic drawings views for explaining the working of the fishing float shown in FIG. 1, FIG. 2A showing an initial state of the fishing float in which a major part of a buoyant body is exposed from water surface, and FIG. 2B showing a state in which a major part of the buoyant body has sunk below the surface because of an increased quantity of the weight pieces provided in a weight piece chamber;

FIGS. 3A and 3B are drawings for explaining the working of a full slip float rig in which the fishing float of FIG. 1 is used, FIG. 3A showing a state in which the fish has not yet bitten the bait, FIG. 3B showing a state after the fish has bitten the bait;

FIGS. 4A to 4D illustrate cross-sectional views corresponding to FIG. 1C, FIGS. 4A to 4D respectively showing a shape of the buoyant body constituting a fishing float according to Embodiment 2, Embodiment 3, Embodiment 3, and Embodiment 4; and

FIGS. 5A to 5C are drawings showing a configuration of experimental equipment employed for verification experiment according to the present disclosure, FIG. 5A showing an overall configuration of the experimental equipment, FIG. 5B showing an arrangement of a hit simulation device, and FIG. 5C showing a configuration of a float stopper plate.

### DESCRIPTION OF EMBODIMENTS

### Embodiment 1

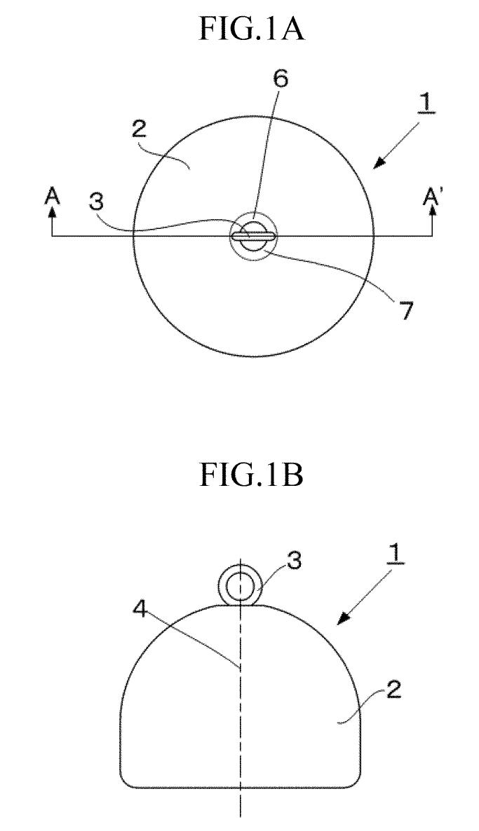

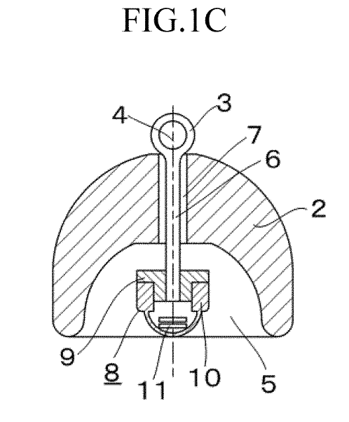

FIG. 1 includes drawings each showing a configuration of a fishing float according to Embodiment 1 of the present disclosure, FIG. 1A being a plan view of the fishing float, FIG. 1B being a side view of the fishing float, and FIG. 1C being a cross-sectional view of the fishing float, taken along a plane indicated by a line A-A′ in FIG. 1A. As shown in FIGS. 1A to 1C, the fishing float 1 includes a buoyant body 2, and a line-passing ring 3 protruding from the upper surface of the buoyant body 2.

The buoyant body 2 serves to provide buoyancy to the fishing float 1 and, in the present embodiment, is formed of a solid body made of a foamed plastic. As shown in FIG. 1A, the buoyant body 2 has a circular shape in a plan view, and constitutes a rotating body that rotates about a rotation center coinciding with a central axis 4 shown in FIG. 1C. As shown in FIG. 1C, the buoyant body 2 includes a recess 5 located on the lower side thereof. The recess 5 is formed so as to be deepest at the central axis 4, and become shallower in a direction away from the central axis 4. Thus, the buoyant body 2 is formed in a bell shape as a whole. With such a shape, the buoyant body 2 encounters greater resistance when descending, in other words sinking downward, in the water. Accordingly, the fishing float 1 is less likely to sink, at least compared with an existing spindle-shaped fishing float.

As shown in FIG. 1C, the buoyant body 2 includes a through hole 6 formed at the center of the buoyant body 2 so as to penetrate therethrough in an up-down direction. The through hole 6 is a circular hole having a circular shape along a non-illustrated cross-section, and located such that the central axis of the through hole 6 coincides with the central axis 4 of the buoyant body 2. In addition, the through hole 6 serves as an air release path for releasing air from the recess 5, when the buoyant body 2 lands on the water with the recess 5 oriented downward. Accordingly, since air is kept from residing in the recess 5, the fishing float 1 can assume a stabilized posture, upon being cast and landing on the water with the lower side of the buoyant body 2 oriented downward.

Further, the fishing float 1 includes a shaft member 7 penetrating through the buoyant body 2 in the up-down direction. The shaft member 7 is a round bar made of stainless steel, and inserted in the through hole 6. The line-passing ring 3 is fixed to the upper end portion of the shaft member 7, and a weight piece chamber 8 is attached to the lower end portion of the shaft member 7. The shaft member 7 is smaller in diameter than the through hole 6. Accordingly, a gap is defined between the through hole 6 and the shaft member 7, because of which the air-release function of the through hole 6 can be maintained, despite inserting the shaft member 7 in the through hole 6. In addition, the shaft member 7 can freely rotate about the central axis 4, inside the through hole 6.

The line-passing ring 3 and the weight piece chamber 8 are larger in diameter than the through hole 6, and therefore the shaft member 7 is prevented from falling off from the through hole 6. With such setting of the diameters of the line-passing ring, the line-passing ring 3 and the weight piece chamber 8 are prevented from being separated from the buoyant body 2, as long as the line-passing ring 3 and the weight piece chamber 8 are fixed to the shaft member 7. That is how the line-passing ring 3 and the weight piece chamber 8 are supported by the buoyant body 2. In addition, the distance between the lower end portion of the line-passing ring 3 and the weight piece chamber 8 (length of the shaft member 7 between the lower end portion of the line-passing ring 3 and the weight piece chamber 8) is slightly longer than the through hole 6. Therefore, the line-passing ring 3 and the weight piece chamber 8 can be moved in the up-down direction, though the travel range is delimited by the difference in length between the shaft member 7 and the through hole 6.

The weight piece chamber 8 includes a base portion 9 and a cap 10. The base portion 9 and the cap 10 are both made of stainless steel. The base portion 9 is coupled to the lower end portion of the shaft member 7, and the cap 10 is removably attached to the base portion 9. One or more weight pieces 11 are accommodated inside the weight piece chamber 8. The weight piece 11 is a small piece of a lead plate. The weight piece chamber 8 and the weight piece 11 serve as a weight that adjusts the buoyancy and the position of the center of gravity of the fishing float 1. When the cap 10 is removed, a part or the whole of the weight pieces 11 accommodated in the weight piece chamber 8 can be taken out. Alternatively, one or more weight pieces 11 can be added in the weight piece chamber 8. Thus, the quantity of the weight pieces 11 accommodated in the weight piece chamber 8 can be increased or decreased, when the cap 10 is removed. The buoyancy and the position of the center of gravity of the fishing float 1 can be adjusted, by thus increasing or decreasing the quantity of the weight pieces 11.

Now, when using the fishing float 1 in the full slip float fishing, it is necessary to adjust the weight of the fishing float 1, so as to allow substantially the entirety of the buoyant body 2 to sink under the water, leaving only the line-passing ring 3 exposed on the water surface. When the fishing float 1 is too light, a major part of the buoyant body 2 is exposed on the water surface. In such a case, the posture of the fishing float 1 is not stabilized. In other words, the fishing float 1 is prone to turn over, which is undesirable. Conversely, when the weight of the fishing float 1 is greater than the buoyancy, the fishing float 1 completely submerges under the water, owing to the self-weight.

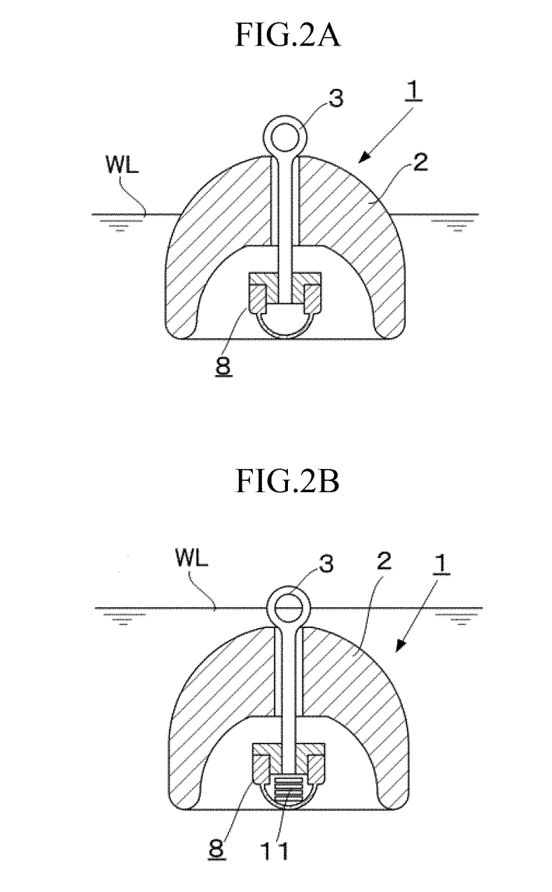

The appropriate weight of the fishing float 1 varies depending on the weight of the rig to be employed, water temperature and salt concentration of the fishing area, and so forth. Accordingly, the weight of the fishing float 1 is unable to be optimized, at the stage of manufacturing the fishing float 1. For such a reason, the fishing float 1 is configured so as to adjust the overall weight, by increasing or decreasing the quantity of the weight pieces 11 to be accommodated in the weight piece chamber 8, as described above. For example, when the majority of the buoyant body 2 is exposed on the water surface (above water line WL) in an initial state, as shown in FIG. 2A, the weight pieces 11 should be added in the weight piece chamber 8, to adjust the overall weight of the fishing float 1. To be more detailed, the weight pieces 11 are added in the weight piece chamber 8, until the entirety of the buoyant body 2 submerges under the water, and the center of the line-passing ring 3 is located at the water surface (water line WL), as shown in FIG. 2B. Through the mentioned process, the weight of the fishing float 1 can be adjusted so as to expose only the line-passing ring 3 on the water surface.

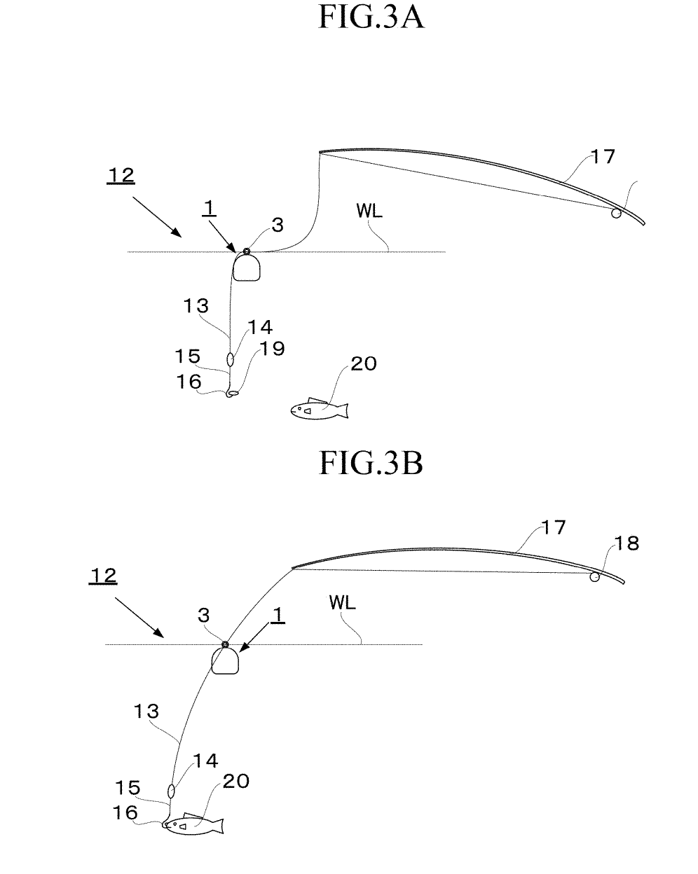

The working and advantageous effects of the fishing float 1 will now be described hereunder. As described above, the fishing float 1 is primarily utilized to constitute a part of a full slip float rig. As shown in FIG. 3A, the full slip float rig 12 includes a fishing line 13, a fishing float 1, a sinker 14, a leader 15, and a fishing hook 16. The fishing line 13 is wound on a reel 18 attached to a fishing rod 17, and paid out by a non-illustrated angler as desired. The fishing line 13 paid out from the reel 18 extends to the fishing float 1 through the tip of the fishing rod 17, and then into the water through the line-passing ring 3 of the fishing float 1. The sinker 14 is attached to the distal end of the fishing line 13 located in the water, and the leader 15 is connected to the sinker 14, so as to hang down in the water. The fishing hook 16 is attached to the distal end of the leader 15, and a bait 19 is attached to the fishing hook 16.

With the full slip float rig 12, the depth of the fishing hook 16 and the bait 19 can be changed as desired. To be more detailed, when the fishing line 13 is paid out from the reel 18, the fishing hook 16 and the bait 19 descend (sink to a deeper level). When the fishing line 13 is taken up on the reel 18, the fishing hook 16 and the bait 19 ascend (float up to a shallower level). Since the depth of the fishing hook 16 and the bait 19 can thus be adjusted as desired, the full slip float rig 12 is useful when what is known as range, in other words the depth of the layer where fish 20 swims, is unknown.

When the fish 20 bites the bait 19 and then attempts to swim away with the bait 19 in the mouth as shown in FIG. 3B, tension is generated in the leader 15. The tension generated in the leader 15 is transmitted to the fishing line 13 via the sinker 14. Accordingly, the fishing line 13 is pulled by the fish 20. Since the fishing line 13 running through the line-passing ring 3 can freely move with respect to the line-passing ring 3 as described above, in other words the line-passing ring 3 does not limit or restrict the movement of the fishing line 13, the force with which the fish 20 is pulling the fishing line 13 is directly transmitted to the fishing rod 17. Therefore, the non-illustrated angler holding the fishing rod 17 can directly sense the force with which the fish 20 is pulling the fishing line 13 (what is known as “pull”). To be more detailed, the angler can directly sense the force with which the fish 20 tilts the fishing rod 17 so as to draw the tip portion of the fishing rod 17 into the water. Upon sensing the “pull”, the angler perceives that the fish 20 has bitten the bait 19, and tries to hook the fish 20 on the fishing hook 16, by drawing up the fishing hook 16 (what is known as “strike”). Thus, the full slip float rig 12 incorporated with the fishing float 1 enables the angler to directly sense the “pull” of the fish 20, and to “strike” without delay. Consequently, the angler is less likely to “strike” with some delay and miss the fish 20, compared with the case of using an existing fishing float.

Further, since the fishing line 13 running through the line-passing ring 3 can freely move with respect to the line-passing ring 3, the force with which the fish 20 is pulling the bait 19 is not transmitted to the fishing float 1 via the line-passing ring 3, despite the mentioned force being transmitted to the fishing line 13. Accordingly, the fishing float 1 is exempted from being moved by the pull of the fish 20. Likewise, the fishing float 1 is exempted from being drawn into the water, by the pull of the fish 20. Further, as described above, the buoyant body 2 includes the recess 5 located on the lower side, which serves to increase the resistance, when the buoyant body 2 is about to sink. Therefore, the fishing float 1 does not readily sink, even though the force with which the fish 20 is pulling the fishing line 13 is transmitted to the buoyant body 2. In other words, the fishing float 1 remains at the water surface (water line WL) without sinking downward, despite the fish 20 pulling the fishing line 13. Consequently, only the fishing line 13 is drawn into the water.

### Embodiment 2

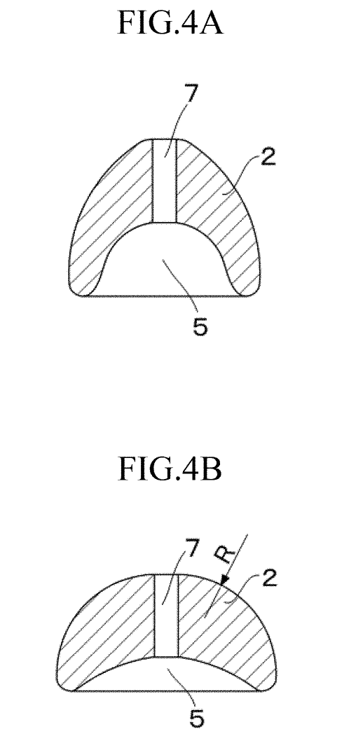

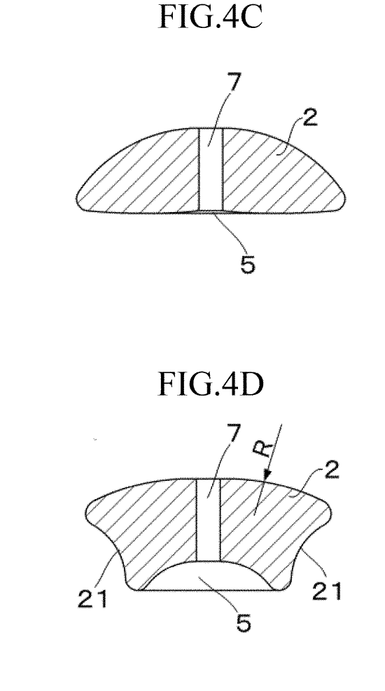

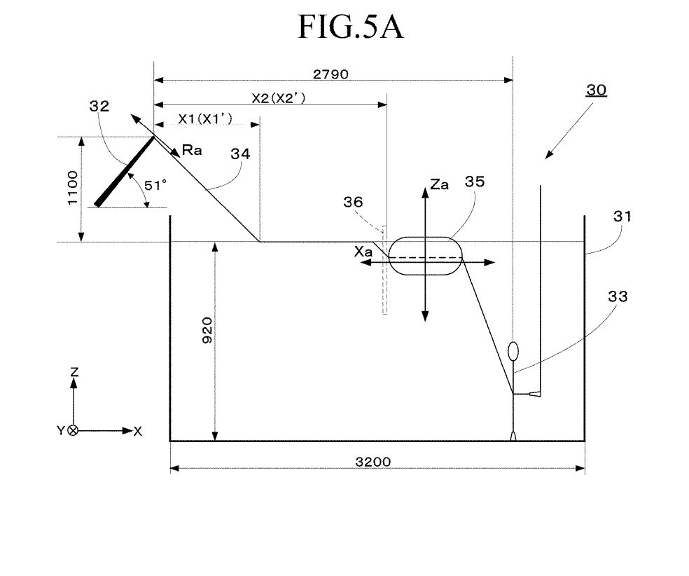

The shape and form of the fishing float 1, in particular the shape of the buoyant body 2, are not limited to the example according to Embodiment 1. As shown in FIG. 4A, the buoyant body 2 may be extended (lengthened) in the up-down direction, so as to make the upper portion of the buoyant body 2 more slender, and make the recess 5 deeper.

### Embodiment 3

The buoyant body 2 may be formed as shown in FIG. 4B. More specifically, the buoyant body 2 may be contracted (shortened) in the up-down direction, with an increase in curvature radius R of the upper surface of the buoyant body 2, and a decrease in depth of the recess 5, thus to make the buoyant body 2 generally flat.

### Embodiment 4

The buoyant body 2 may be formed as shown in FIG. 4C. More specifically, the buoyant body 2 may be made even flatter as a whole, and the recess 5 on the lower side of the buoyant body 2 may be made extremely shallow.

### Embodiment 5

The buoyant body 2 may be formed as shown in FIG. 4D. More specifically, the curvature radius R of the upper surface of the buoyant body 2 may be further increased so as to make the slope of the upper surface of the buoyant body 2 more gentle, and a second recess 21 may be formed along the side face of the buoyant body 2.

In the foregoing embodiments, as described above, the line-passing ring 3 is attached to the fishing float 1 so as to protrude upward from the upper surface of the buoyant body 2. When the full slip float rig 12 is set up using the fishing float 1, the fishing line 13 is passed through the line-passing ring 3. Accordingly, the fishing line 13 can freely, and constantly, move back and forth with respect to the line-passing ring 3, and therefore the force with which the fish 20 pulls the fishing line 13, in other words the “pull” of the fish 20, is directly transmitted to the fishing rod 17. As result, the angler can directly sense the “pull” of the fish 20.

In addition, the recess 5 is formed on the lower side of the buoyant body 2, and therefore the buoyant body 2 encounters a relatively large resistance, when moving downward (sinking) in the water. Accordingly, the fishing float 1 is prevented from moving downward (sinking). Because of this, the fishing float 1 does not readily sink, even when the fish 20 pulls the fishing line 13. Consequently, when the fish 20 pulls the fishing line 13, only the fishing line 13 is drawn into the water.

(Verification Experiment)

To compare the performance of the fishing float 1 with that of existing products, a verification experiment was carried out with respect to Comparative Examples A to D, and the float according to the disclosure. The Comparative Example A is a float with ring according to the conventional art, and the ring for passing the fishing line is located on the lower end portion of the float. In other words, the Comparative Example A is configured so as to float on the water surface, with the line-passing ring located on the lower side. The Comparative Examples B and C are sliding floats according to the conventional art, and each include an inner through hole for passing the fishing line, located at the center of the float. The Comparative Examples B and C are configured such that the inner through hole is oriented vertically to the water surface, when the float is on the water. The Comparative Example D is also a sliding float according to the conventional art, but configured such that the inner through hole is oriented parallel to the water surface, in other words horizontal, when the float is on the water. The float according to the disclosure is the fishing float 1 according to Embodiment 1.

(Experimental Equipment)

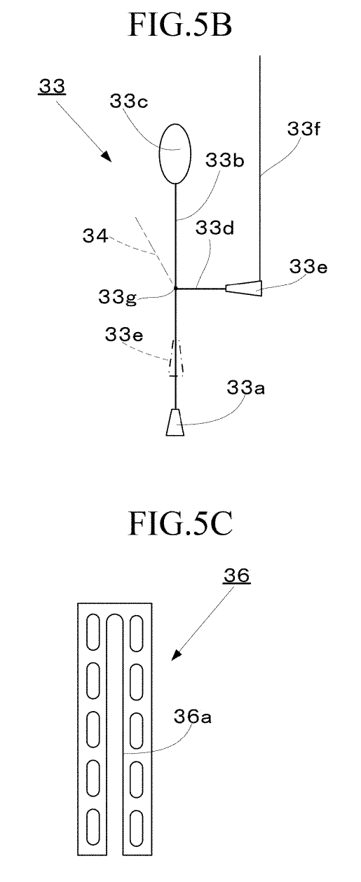

FIGS. 5A to 5C are drawings showing a configuration of experimental equipment 30. As shown in FIG. 5A, the experimental equipment 30 includes a water tank 31, a rod tip 32, and a hit simulation device 33. The water tank 31 has a rectangular shape, with a length of 3.2 m and a width of 1.2 m. The front face of the water tank 31, corresponding to the face illustrated in FIG. 5A, is formed of a transparent material. In the water tank 31, clear water is provided to a depth of 0.92 m. Here, the width of the water tank refers to the inner dimension of the water tank 31 taken in a direction vertical to the sheet face of FIG. 5A. The rod tip 32 was taken from a commercially available fishing rod, and set at an elevation angle of 51 degrees. The height of the point of the rod tip 32 measured from the water surface in the water tank 31 is 1.1 m. A fishing line 34 is tied to the point of the rod tip 32. The fishing line 34 is routed through the water surface in the water tank 31 and a fishing float 35, which is the subject of the experiment, and into the water in the water tank 31. The distal end portion of the fishing line 34 is tied to the hit simulation device 33. Here, the weight of the fishing float 35 and the rig provided under the fishing float 35, in other words the weight imposed on the fishing float 35, is adjusted so as to equilibrate with the buoyancy of the fishing float 35. In short, the weight imposed on the fishing float 35 is adjusted so as to locate the entirety of the fishing float 35 under the water surface, in the state shown in FIG. 5A. The weight imposed on the fishing float 35 is adjusted so as make the surplus buoyancy or residual buoyancy of the fishing float 35 zero.

The hit simulation device 33 serves to reproduce the behavior of the fishing hook arising from the hit of the fish. As shown in FIG. 5B, the hit simulation device 33 includes a retainer sinker 33a, a retainer line 33b, a buoyant body 33c, a load line 33d, a load sinker 33e, and an auxiliary line 33f. The retainer sinker 33a reaches the bottom of the water tank 31, to retain the hit simulation device 33 at a specific position in the water tank 31. An end of the retainer line 33b is tied to the retainer sinker 33a. The other end of the retainer line 33b is tied to the buoyant body 33c. Since the buoyant body 33c receives buoyancy from the clear water provided in the water tank 31, the retainer line 33b is pulled by the buoyant body 33c. The fishing line 34 and the load line 33d are tied to the retainer line 33b, at a midpoint 33g between the retainer sinker 33a and the buoyant body 33c. The load sinker 33e is attached to the distal end portion of the load line 33d. The auxiliary line 33f is attached to the load sinker 33e, and the other end of the auxiliary line 33f is supported by a non-illustrated support point. In the state indicated by solid lines in FIG. 5B, the load sinker 33e is suspended with the auxiliary line 33f, and therefore the weight of the load sinker 33e is not imposed on the buoyant body 33c.

When the other end of the auxiliary line 33f is removed from the support point, the load sinker 33e is no longer supported by the auxiliary line 33f, and therefore freely falls in the water of the water tank 31. When the load sinker 33e falls, the midpoint 33g once moves downward by being pulled by the load sinker 33e. Then the midpoint 33g moves upward, because the load sinker 33e is lifted owing to the buoyancy of the buoyant body 33c. Thus, the midpoint 33g moves down and up, when the other end of the auxiliary line 33f is removed from the support point. With such a downward and upward movement of the midpoint 33g, the downward and upward movement of the fishing hook, caused by a hit of fish, can be simulated. That is how the hit simulation device 33 reproduces the hit of fish. Here, the length of the load line 33d is approximately 100 mm, and the load sinker 33e is of the size of No. 2, having a weight of approximately 7.5 g.

FIG. 5C is a plan view of a float stopper plate 36, seen from the side of the rod tip 32. As shown in FIG. 5C, the float stopper plate 36 is a flat plate having a line-passing slit 36a formed at the central portion. By providing the float stopper plate 36 in the experimental equipment 30, in contact with the end portion of the fishing float 35 on the side of the rod tip 32, and passing the fishing line 34 through the line-passing slit 36a, the fishing float 35 is restricted from moving in an X-axis direction by the float stopper plate 36, and therefore the fishing float 35 is unable to move toward the rod tip 32. In contrast, the fishing line 34 is not restricted from moving in the X-axis direction and a Z-axis direction, by the float stopper plate 36. As will be subsequently described, the verification experiment was carried out with the float stopper plate 36 provided in the experimental equipment 30, and without the float stopper plate 36 in the experimental equipment 30.

The description given below will be based on a rectangular coordinate system according to FIG. 5A. To be more detailed, the X-axis is taken in the longitudinal direction of the water tank 31, and the direction from the rod tip 32 toward the hit simulation device 33 will be defined as positive X-axis direction. The Y-axis is taken in the width direction of the water tank 31, and the direction from the front face toward the rear face of the sheet of FIG. 5A will be defined as positive Y-axis direction. The Z-axis is taken in the depth direction of the water tank 31, and the direction from the lower side toward the upper side will be defined as positive Z-axis direction.

(Experiment Process)

The verification experiment was carried out by placing the Comparative Examples A to D and the float according to the disclosure in the experimental equipment 30 shown in FIG. 5A, and then activating the hit simulation device 33. To be more detailed, the auxiliary line 33f was removed from the support point to cause the load sinker 33e to freely fall, and the respective behaviors of the rod tip 32, the fishing line 34, and the fishing float 35 were measured. Specifically, the measurement was performed with respect to a length X1 in the X-axis direction from the point of the rod tip 32 to the landing point of the fishing line 34 on the water, a length X2 in the X-axis direction from the point of the rod tip 32 to the fishing float 35, a swing amplitude Ra of the point of the rod tip 32, a movement range Za of the fishing float 35 in the Z-axis direction, in other words in the up-down direction, and a movement range Xa of the fishing float 35 in the X-axis direction, in other words in the front-back direction. The swing amplitude Ra of the point of the rod tip 32 was measured in a direction orthogonal to the axis of the rod tip 32, in an XZ-plane.

(Experiment 1)

First, the experiment was carried out without restricting the fishing float 35 from moving. In other words, the experiment was carried out without providing the float stopper plate 36 in the experimental equipment 30. The result is shown in Table 1. In this experiment, the lengths X1 and X2 in the X-axis direction were measured before the hit simulation device 33 was activated, and after the hit simulation device 33 was activated and then the load sinker 33e stopped moving. In Table 1, the lengths X1 and X2 in the X-axis direction, measured before the hit simulation device 33 was activated, are respectively denoted by X1 and X2, and the lengths X1 and X2 in the X-axis direction, measured after the hit simulation device 33 was activated and then the load sinker 33e stopped moving, are respectively denoted by X1′ and X2′.

TABLE 1

| Float | X1/X1′ | X2/X2′ | Ra | Za | Xa |
|---|---|---|---|---|---|
| Comparative | 1,140/1,090 | 2,350/2,175 | 5 | 5 | 3 |
| Example A | | | | | |
| Comparative | 1,540/1,530 | 2,730/2,690 | 6 | 20 | 30 |
| Example B | | | | | |
| Comparative | —/1,200 | 2,550/2,495 | 6 | 17 | 20 |
| Example C | | | | | |
| Comparative | —/1,190 | 2,302/2,060 | 5 | 6 | 15 |
| Example D | | | | | |
| Float | —/1,540 | 2,710/2,700 | 10 | 12 | 6 |
| according to | | | | | |
| Disclosure | | | | | |

(Experiment 2)

Thereafter, the experiment was carried out, restricting the fishing float 35 from moving in an X-axis direction. In other words, the experiment was carried out with the float stopper plate 36 located in contact with the end portion of the fishing float 35 on the side of the rod tip 32, as indicated by dash-dot lines in FIG. 5A. The result is shown in Table 2.

TABLE 2

| Float | X1 | X2 | Ra | Za | Xa |
|---|---|---|---|---|---|
| Comparative | 1,390 | 2,710 | 7 | 4 | — |
| Example A | | | | | |
| Comparative | 1,530 | 2,710 | 4 | 12 | — |
| Example B | | | | | |
| Comparative | 1,470 | 2,710 | 6 | 10 | — |
| Example C | | | | | |
| Comparative | 1,550 | 2,710 | 7 | 8 | — |
| Example D | | | | | |
| Float | 1,550 | 2,710 | 9 | 7 | — |
| according to | | | | | |
| Disclosure | | | | | |

As is apparent from Table 1 and Table 2, the swing amplitude Ra of the point of the rod tip 32 of the float according to the disclosure is larger than that of all the Comparative Examples A to D. The larger swing amplitude Ra of the point of the rod tip 32 means that the rod tip 32 swings over a wider range owing to the “pull” of the fish. Therefore, the float according to the disclosure allows the angler to more strongly sense the “pull” of the fish, than any of the Comparative Examples A to D.

As described thus far, the fishing float 1 is suitable for the slip float fishing. Setting up the full slip float rig 12 using the fishing float 1 enables the “pull” generated by the “bite” of the fish 20 to be transmitted to the angler, without fail and without delay. Accordingly, even an unskilled angler can “strike” at an appropriate timing.

It is to be noted that the technical scope of the present disclosure is not limited to the foregoing embodiments. The present disclosure may be modified, applied, or improved as desired, within the scope of the technical idea set forth in the appended claims.

For example, the shapes of the buoyant body 2 shown in FIGS. 1A to 1C and FIGS. 4A to 4D are only exemplary, and not intended to limit the shape of the buoyant body 2. The size of the buoyant body 2 may also be selected as desired. The size of the buoyant body 2 is to be determined, primarily depending on the size of the target fish 20. The bigger the target fish 20 is, the larger the full slip float rig 12 becomes, and so does the buoyant body 2.

Although the buoyant body 2 is formed as a solid body from a foamed plastic in the foregoing embodiments, the material and the structure of the buoyant body 2 are not limited thereto. The buoyant body 2 may be made of a natural material having a low specific gravity, such as wood (for example, balsawood or paulownia). The structure of the buoyant body 2 is not limited to the solid body. The buoyant body 2 may have a hollow structure. Further, in the case of forming the buoyant body 2 as a hollow body from a translucent material, a light-emitting device (for example, LED lamp or chemical light) may be provided inside the buoyant body 2, for use as a guide in the case of night angling.

Whereas no specific description was given regarding the method for coupling the line-passing ring 3 to the shaft member 7, as well as the shaft member 7 to the weight piece chamber 8, in the foregoing embodiments, any of known methods may be selected as desired, as the mentioned coupling method. For example, the line-passing ring 3 may be coupled to the shaft member 7 by brazing, welding, swaging, or shrink fitting. Alternatively, the line-passing ring 3 may be screwed to the shaft member 7.

Further, the line-passing ring 3 and the shaft member 7 may be integrally formed, for example by die-casting. The above also applies to the case of coupling the shaft member 7 to the weight piece chamber 8.

Whereas no specific description was given either, regarding the method for removably attaching the cap 10 to the base portion 9 of the weight piece chamber 8 in the foregoing embodiment, any of known methods may be selected as desired, also as the mentioned attaching method. For example, a female thread may be formed on the inner surface of the cap 10, and a male thread may be formed on the outer surface of the base portion 9, so as to screw the cap 10 onto the base portion 9. Alternatively, the cap 10 may be configured so as to be tightly fitted on the base portion 9 with the elasticity of the cap 10 itself, upon being pressed against the base portion 9.

Although the weight piece 11 is exemplified by small pieces of a lead plate in the foregoing embodiment, the weight piece 11 is not limited to a material cut away from a plate material. In addition, the material of the weight piece 11 is not limited to lead. The weight piece 11 may be formed of a metal other than lead, or a non-metal material. It suffices that the weight piece 11 be a “fragment” or a “small piece” of the sinker, having a size that can be accommodated in the weight piece chamber 8, and the material and the shape are not specifically limited. For example, a metal wire cut in a short length may be employed as the weight piece 11. Alternatively, a spherical metal piece, such as a lead ball popularly called “gun pellet”, may be employed as the weight piece 11.

Although the shaft member 7 and the weight piece chamber 8 (base portion 9 and cap 10) are formed of stainless steel in the foregoing embodiment, the material of the mentioned components is not limited to the stainless steel. These components may be formed of a different metal material, or a non-metal material. For example, the weight piece chamber 8 may be formed of a plastic.

Further, a weight may be provided inside the buoyant body 2, instead of, or in addition to, the weight piece chamber 8. For example, the buoyant body 2 may be formed in a hollow structure, to accommodate the weight inside the buoyant body 2. Alternatively, the buoyant body 2 may be divided into an upper part and a lower part, such that the upper part and the lower part can be separably coupled, to replace the weight, or increase or decrease the quantity thereof

Further, although the fishing float 1 is intended for use in the full slip float rig 12 in the foregoing embodiment, the purpose of use of the fishing float 1 is not limited to the full slip float fishing. The fishing float 1 may also be used in the partial slip float rig. In other words, the stop knot and the bead may be attached to the fishing line 13 in the rig shown in FIGS. 3A and 3B, to delimit the range in which the fishing float 1 can move.

Still further, although the fishing float 1 is intended for use in bait fishing in the foregoing embodiment, the purpose of use of the fishing float 1 is not limited to the bait fishing. The fishing float 1 may also be used for lure fishing. To be more detailed, a lure (artificial bait) may be attached to the rig shown in FIGS. 3A and 3B, in place of the fishing hook 16 and the bait 19.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2016-206665, filed on Oct. 21, 2016, the entire disclosure of which is incorporated by reference herein.

### REFERENCE SIGNS LIST

1 Fishing float
2 Buoyant body
3 Line-passing ring
4 Central axis
5 Recess
6 Through hole
7 Shaft member
8 Weight piece chamber
9 Base portion
10 Cap
11 Weight piece
12 Full slip float rig
13 Fishing line
14 Sinker
15 Leader
16 Fishing hook
17 Fishing rod
18 Reel
19 Bait
20 Fish
21 Second recess
30 Experimental equipment
31 Water tank
32 Rod tip
33 Hit simulation device
33a Retainer sinker
33b Retainer line
33c Buoyant body
33d Load line
33e Load sinker
33f Auxiliary line
33g Midpoint
34 Fishing line
35 Fishing float
36 Float stopper plate
36a Line-passing slit
R Curvature radius
WL Water line (Water surface level)

1. A fishing float comprising:
a buoyant body; and
a line-passing ring,
wherein the buoyant body constitutes a rotating body that rotates about a rotation center passing through the buoyant body in an up-down direction, and includes a recess located on a lower side of the buoyant body and formed so as to recede upward,
the recess is deepest at the rotation center of the rotating body, and becomes shallower in a direction away from the rotation center of the rotating body, and the line-passing ring is supported by the buoyant body, and attached to the buoyant body at a position corresponding to the rotation center of the rotating body, so as to protrude upward from an upper surface of the buoyant body.

2. The fishing float according to claim 1, further comprising a weight located under, and supported by, the buoyant body.

3. The fishing float according to claim 2, further comprising a shaft member penetrating through the buoyant body in the up-down direction,
wherein the line-passing ring is fixed to an upper end portion of the shaft member, and the weight is fixed to a lower end portion of the shaft member.

4. The fishing float according to claim 3, wherein the buoyant body includes a through hole for the shaft member to be inserted, and a gap is defined between the through hole and the shaft member.

5. The fishing float according to claim 2, wherein the weight includes a weight piece chamber for removably accommodating the weight piece.
